(19) United States
(12) Patent Application Publication
(10) Pub. No.: US 2021/0094037 A1
(43) Pub. Date: Apr. 1, 2021

(54) SPECIMEN TUBE HOLDER

(71) Applicant: SUGENTECH, INC., Daejeon (KR)

(72) Inventors: Seungsu AN, Sejong-si (KR); Moonjay SONG, Daejeon (KR); Sungrak KIM, Daejeon (KR); Seungbum YOO, Daejeon (KR); Mi-Jin SOHN, Daejeon (KR)

(73) Assignee: SUGENTECH, INC., Daejeon (KR)

(21) Appl. No.: 17/050,081

(22) PCT Filed: Apr. 26, 2019
(86) PCT No.: PCT/KR2019/005079

§ 371 Date: Oct. 23, 2020

(30) Foreign Application Priority Data
Apr. 26, 2018 (KR) 10-2018-0048482

(51) Int. Cl. B01L 9/06

(52) U.S. Cl. CPC B01L 9/06; B01L 2200/025; B01L 2300/12; B01L 2300/123; B01L 2200/028

(57) ABSTRACT

A specimen tube holder includes a probe-type capacitance liquid level detection sensor having increased sensitivity and thus enables more precise liquid level recognition. A specimen tube holder includes: a central holder; and a lateral holder which is made of a conductive material, is spaced apart from a side surface of the central holder so as to have a receiving space formed between the central holder and the lateral holder to allow a specimen tube to be inserted into the receiving space, and has an inner surface formed to be vertically in contact with at least a part of the outer circumferential surface of the specimen tube received in the receiving space.

### TECHNICAL FIELD

The present invention relates to a specimen tube holder that may improve sensitivity of liquid level detection of a specimen.

### BACKGROUND ART

In general, an automated medical equipment is used for analysis of saliva, blood, urine, or the like. At this time, a medical equipment made up of a conventional fully automated system automatically performs a process of detecting a liquid level of a specimen (saliva, blood, urine, or the like) contained in a specimen tube and inhaling and dispensing the specimen. Here, since the results may vary depending on the amount of the specimen and sample, it is important to aspirate and dispense a correct amount of the specimen and sample.

Such an automated medical equipment is provided so that a plurality of specimen tubes 10 containing collected specimens are mounted on a holder 30, and a probe 20 or a needle then enters the specimen tubes 10 from an upper side to collect the specimen or insert the sample, as illustrated in FIG. 1.

There are various methods of detecting a liquid level of the specimen, but recently, a capacitive liquid level detection (cLLD) method has been widely used.

In such a capacitive liquid level detection method, the liquid level of the specimen is recognized by detecting a change in the amount of electric charge or an electrical signal at the moment when the probe 20 mounted on the equipment touches the liquid level. Therefore, there is an advantage that the signal may be detected very quickly and relatively accurately.

However, there is a problem in that detection sensitivity of the electrical signal may be lowered by substances that interfere with the electrical signal such as Separate Gel contained in the specimen, and the sensitivity changes according to environmental changes such as temperature or humidity, a state of the equipment, an electrical grounding state, or the volume of the sample.

### RELATED ART DOCUMENT

KR 2014-0144367A

### Disclosure

### Technical Problem

An object of the present invention is to provide a specimen tube holder capable of improving detection sensitivity of a liquid level of a specimen by maximizing a capacitance.

The aspects of the present invention are not limited to the aspects mentioned above, and other aspects that are not mentioned will be clearly understood by those skilled in the art from the following description.

### Technical Solution

According to a first embodiment of the present invention, a specimen tube holder includes: a central holder; and a side holder made of a conductive material, disposed to be spaced apart from a side surface of the central holder to form an accommodation space into which a specimen tube is inserted between the central holder and the side holder, and formed so that an inner side surface is longly in contact with at least a portion of an outer circumferential surface of the specimen tube accommodated in the accommodation space in a vertical direction.

A groove having a shape corresponding to a shape of the outer circumferential surface of the specimen tube may be formed on a surface of the side holder facing the specimen tube.

A tension spring may be provided for elastically pressing the specimen tube accommodated in the accommodation space toward the side holder.

The side holder may be installed on one surface of the central holder and the other surface opposite thereto to be spaced apart from each other, and the tension spring may be installed on both side surfaces of the central holder.

A long opening may be formed in a side surface of the side holder in the vertical direction.

According to a second embodiment of the present invention, a modular specimen tube holder includes: an upper holder having an opening through which a specimen tube enters; a lower holder located under the upper holder and connected to a lower side surface of the specimen tube; and a side holder provided between the upper holder and the lower holder, made of a conductive material, and formed so that an inner side surface is longly in contact with at least a portion of an outer circumferential surface of the specimen tube entered through the opening of the upper holder in a vertical direction.

The opening of the upper holder may be formed so that a portion of a circumference thereof is opened toward a diameter direction.

A tension spring may be provided for elastically pressing the specimen tube inserted through the opening of the upper holder toward the side holder.

An opening may be longly formed in a side surface of the side holder in the vertical direction.

The upper holder and the lower holder may be provided to be horizontally coupled to connected upper and lower holders.

According to a third embodiment of the present invention, a block-type specimen tube holder includes: a holder block made of a conductive material, having one or more accommodation spaces into which a specimen tube is inserted, and formed so that an inner side surface is longly in contact with at least a portion of an outer circumferential surface of the specimen tube inserted into the accommodation space in a vertical direction; and a tension spring provided in each accommodation space to elastically press the specimen tube inserted into each accommodation space toward an inner side surface of the accommodation space.

Each accommodation space may be formed to be opened in the vertical direction toward a side surface of the holder block.

### Advantageous Effects

According to the present invention, the capacitance of the specimen tube holder is increased, so that the detection sensitivity of the liquid level of the specimen contained in the specimen tube may be improved.

The effects of the present invention are not limited to the effects mentioned above, and other effects that are not mentioned will be clearly understood by those skilled in the art from the description of the claims.

### DESCRIPTION OF DRAWINGS

The detailed description of the embodiments of the present application described below, as well as the summary set forth above, may be better understood when read in connection with the accompanying drawings. In the drawings, for the purpose of illustrating the present invention, the embodiments are illustrated. However, it should be understood that the present application is not limited to the precise arrangements and means illustrated.

FIG. 1 is a perspective view illustrating a conventional specimen tube holder.

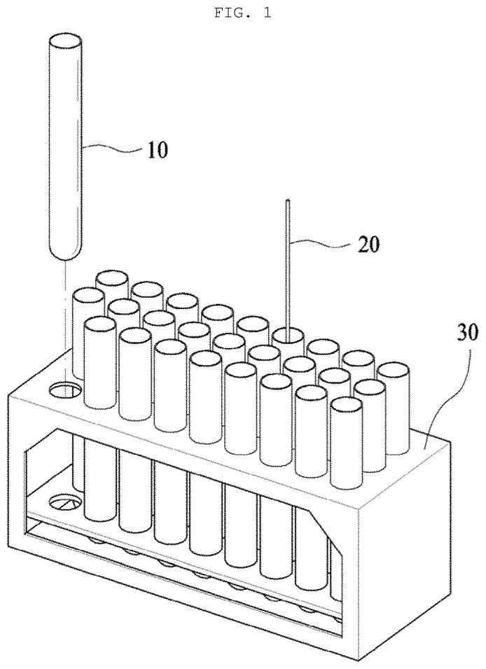

FIG. 2 is a view for describing a capacitance applied by the conventional specimen tube holder.

FIG. 3 is a perspective view illustrating a first embodiment of a specimen tube holder of the present invention.

FIG. 4 is a plan view of FIG. 3.

FIG. 5 is a side view of FIG. 3.

FIG. 6 is a perspective view illustrating a second embodiment of the specimen tube holder of the present invention.

FIG. 7 is a plan view of FIG. 6.

FIG. 8 is a side view of FIG. 6.

FIG. 9 is a perspective view illustrating a specimen tube holder module to which the specimen tube holder of FIG. 6 is coupled.

FIG. 10 is a perspective view illustrating a third embodiment of the specimen tube holder of the present invention.

FIG. 11 is a graph illustrating a change in capacitance for each specimen capacity by the conventional specimen tube holder and the specimen tube holder of the present invention.

### BEST MODE

Hereinafter, embodiments of the present invention in which the object of the present invention may be realized in detail will be described with reference to the accompanying drawings. In the description of the present embodiment, the same names and the same reference numerals are used for the same components, and additional descriptions thereof will be omitted.

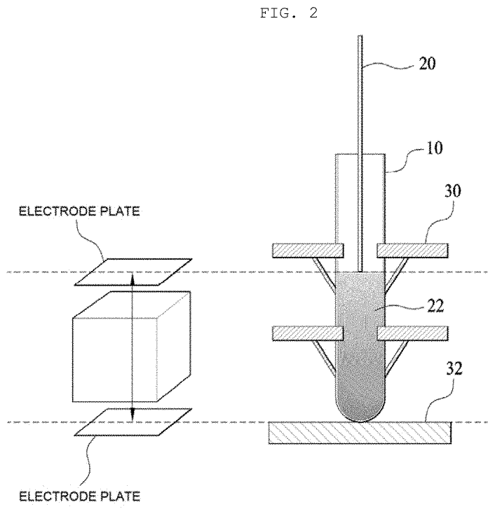

In the conventional capacitance liquid level detection method, as illustrated in FIG. 2, when a probe 20 inserted into a specimen tube 10 touches a liquid level of a specimen 22, a bottom surface 32 of a region where the probe 20 and a lower side surface of the specimen tube 10 are in contact with each other serves as an electrode plate.

At this time, a capacitance is proportional to a product of a dielectric constant and an area of the electrode plate, and is inversely proportional to a distance of the electrode plate.

In the conventional capacitance liquid level detection method, various attempts have been made, such as applying a noise filter or a cooling fan, or changing a detection algorithm, in order to solve various factors affecting a liquid level detection of the specimen, but this has not been a fundamental solution. In particular, when environmental changes (sudden changes in temperature and humidity, and the like) occur in a place where a liquid level detection equipment is used, a liquid level detection sensitivity of the specimen is affected, making it impossible to properly recognize the liquid level of the specimen and a sample, and accordingly, there were cases where automatic inhaling and dispensing were not performed accurately.

Therefore, according to the present invention, in order to minimize an influence of various factors including the environment on the liquid level detection of the specimen, it is desired to increase a capacitance of a specimen tube holder.

That is, as the capacitance of the specimen tube holder for the same specimen becomes higher than before, a sensitivity of recognizing the liquid level of the specimen will be improved in proportion to the increased capacitance, and accordingly, even if the environment changes in the place where the liquid level detection equipment is used, if the capacitance of the specimen tube holder is large, it may not have a significant effect on the liquid level detection sensitivity of the specimen.

Meanwhile, according to the present invention, in order to increase the capacitance of the specimen tube holder without changing the size or shape of an existing specimen tube 10, it is desired to change the shape or material of the specimen tube holder.

That is, according to the present invention, in order to increase the capacitance of the specimen tube holder, it is desired to change a material constituting the specimen tube holder from a non-conductive material such as plastic to a conductive material such as aluminum, and an outer circumferential surface of the specimen tube and an inner side surface of the specimen tube holder were longly in contact with each other in a vertical direction so that a contact area between the specimen tube and the specimen tube holder was greatly increased. Since the capacitance is proportional to the product of the dielectric constant and the area of the electrode plate and is inversely proportional to the distance of the electrode plate, the capacitance of the holder may be increased by increasing the area of the specimen tube holder in contact with the specimen tube 10.

Hereinafter, embodiments of the present invention to which the technical concept of the present invention is applied will be described.

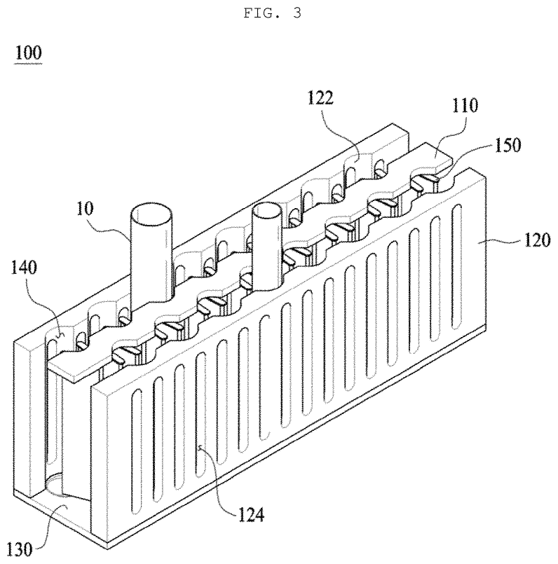

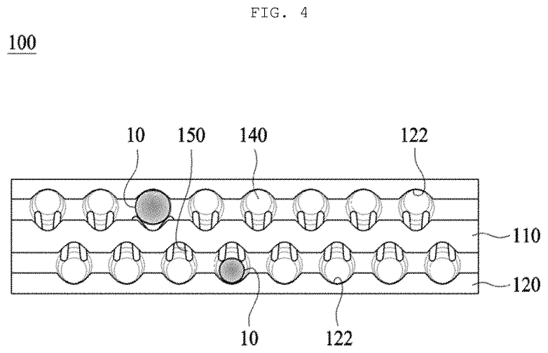

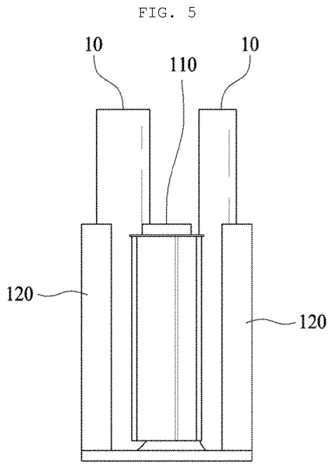

FIGS. 3 to 5 are views illustrating a specimen tube holder 100 according to a first embodiment of the present invention.

The specimen tube holder 100 according to the first embodiment of the present invention may include a central holder 110 and a side holder 120.

The central holder 110 may be disposed at an upper center of the specimen tube holder 100 to have a longitudinal direction in any one direction.

In addition, the side holder 120 is made of a conductive material, is disposed to be spaced apart from a side surface of the central holder 110, and may be disposed in parallel with the central holder 110.

An accommodation space 140 into which the specimen tube 10 containing the specimen is inserted may be formed between the central holder 110 and the side holder 120 spaced apart from each other.

In addition, a lower side surface 130 for supporting a lower side surface of the specimen tube 10 accommodated in the accommodation space while forming a lower surface of the specimen tube holder 100 may be provided.

At this time, the side holder 120 may be formed to maximize a contact area between the specimen tube 10 and the side holder 120 by making an inner side surface thereof be longly in contact with at least a portion of an outer circumferential surface of the specimen tube 10 accommodated in the accommodation space 140 in a vertical direction. To this end, the side holder 120 may be formed to have a predetermined length in the vertical direction.

In addition, a groove 122 having a shape corresponding to a shape of the outer circumferential surface of the specimen tube 10 may be formed on a surface of the side holder 120 facing the specimen tube 10 so that an area in contact with the outer circumferential surface of the specimen tube 10 inserted into the accommodation space 140 is increased.

That is, when the specimen tube 10 has a circular cross section, a groove 122 having a circular inner side surface may be formed in a portion of the side holder 120 facing the specimen tube 10.

Such a groove 122 may be formed on a side surface of the central holder 110 facing the side holder 120, and may be formed to be spaced apart at a plurality of locations along the longitudinal direction of the central holder 110 and the side holder 120.

In addition, a tension spring 150 may be provided in the specimen tube holder 100. The tension spring 150 is provided to elastically press the specimen tube 10 accommodated in the accommodation space 140 from the central holder 110 toward the side holder 120, and allows the specimen tube 10 to be in close contact with the side holder 120 made of a conductive material in a wider area. In addition, even if a diameter of the specimen tube 10 is changed, the specimen tube 10 may be stably supported by the tension spring 150.

That is, according to the present invention, the specimen tubes 10 of various diameters may be stably accommodated and supported, and the area of the side holder 120 in contact with the specimen tube 10 may be increased by making the specimen tubes 10 of various diameters be longly in contact with the inner side surface of the side holder 120 in the vertical direction.

The side holders 120 may be installed to be spaced apart from each other on one side of the central holder 110 and the other side opposite to one surface of the central holder 110, and the tension springs 150 may be provided on both side surfaces of the central holder 110 to elastically press the specimen tube 10 inserted into the accommodation space 140 toward both side holders 120.

In addition, openings 124 may be formed to be long in the vertical direction on the side surface of the side holder 120 so that a level of the specimen contained in the specimen tube 10, specimen information, a state of the sample, or a barcode attached to the specimen tube 10 may be confirmed from the side surface. The openings 124 may be finished with a transparent window or may be opened without any finishing treatment.

Therefore, when the specimen tube 10 is inserted into the accommodation space 140, the side surface of the specimen tube 10 is in close contact with the side holder 120 made of the conductive material while the specimen tube 10 is elastically pressed toward the side holder 120 by the tension spring 150, and as a result, the area of the side holder 120 in contact with the specimen tube 10 is increased, thereby making it possible to increase the capacitance of the specimen tube holder 100.

At this time, as the material of the side holder 120, any material having conductivity is possible, but since it needs to have some degree of rigidity and mechanical processing is possible, metals such as aluminum, copper, and stainless steel, or a conductive polymer may be used as the side holder 120.

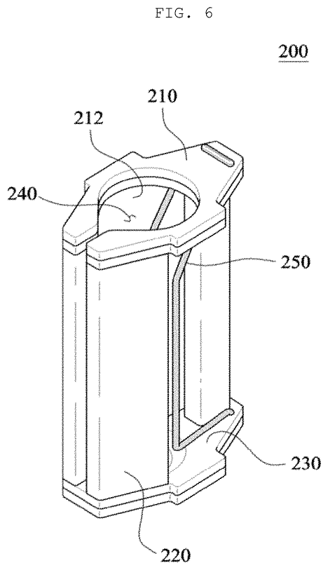

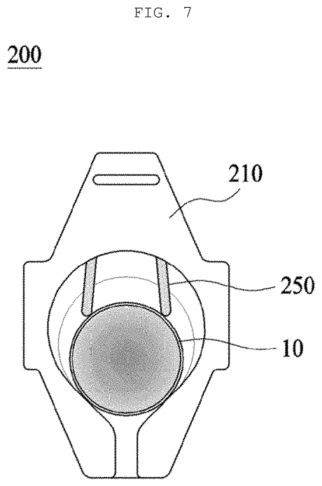

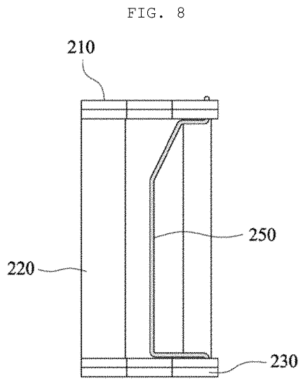

On the other hand, a modular specimen tube holder 200 according to a second embodiment of the present invention may include an upper holder 210, a lower holder 230, a side holder 220, and a tension spring 250, as illustrated in FIGS. 6 to 8.

The upper holder 210 forms an upper surface of the specimen tube holder 200, and an opening 212 through which the specimen tube 10 enters may be formed therein.

In addition, the lower holder 230 is located under the upper holder 210 and is connected to a lower side surface of the specimen tube 10 to support the specimen tube 10.

The side holder 220 is provided between the upper holder 210 and the lower holder 230, is made of a conductive material, and may be formed to maximize an area in contact with the specimen tube 10 by making an inner side surface thereof be longly in contact with at least a portion of an outer circumferential surface of the specimen tube 10 entered through the opening 212 in a vertical direction. At this time, a surface where the side holder 220 and the specimen tube 10 are connected may be formed to take a shape corresponding to the outer circumferential surface of the specimen tube 10.

Therefore, an accommodation space 240 in which the specimen tube 10 is accommodated may be formed as a space surrounded by the upper holder 210, the lower holder 230, and the side holder 220.

Meanwhile, the opening 212 of the upper holder 210 may be formed such that a portion of a circumference thereof is opened toward a diameter direction.

In addition, the opening 212 may be formed to be longly opened in the vertical direction along the longitudinal direction of the specimen tube 10 on a side surface of the side holder 220. Through the opened space of the side holder 220, a level of the specimen contained in the specimen tube 10, specimen information, a state of the sample, or a barcode attached to the specimen tube 10 may be confirmed.

At this time, as the material of the side holder 220, any material having conductivity is possible, but since it needs to have some degree of rigidity and mechanical processing is possible, metals such as aluminum, copper, and stainless steel, or a conductive polymer may be used as the material of the side holder 120.

In addition, the tension spring 250 for elastically pressing the specimen tube 10 inserted through the opening 212 of the upper holder 210 toward one side of the side holder 220 may be provided on the other side of the side holder 220. For example, the tension spring 250 may be provided opposite to a position where the side holder 220 is opened so as to press the specimen tube 10 toward the side where the side holder 220 is opened. As the tension spring 250 presses the specimen tube 10 toward one side of the side holder 220, the area of the side holder 220 in contact with the specimen tube 10 may be increased, and accordingly, a capacitance of the specimen tube holder 200 may be increased.

Meanwhile, the modular specimen tube holders 200 may be horizontally coupled to each other. To this end, the upper holder 210 and the lower holder 230 may be provided to be horizontally coupled to the connected upper holder 210 and lower holder 230.

That is, although not illustrated in the drawings, protrusions are formed at portions of rims of the upper holder 210 and the lower holder 230, and insertion portions for accommodating the protrusions are formed in other portions of rims of the other upper holder 210 and lower holder 230 connected thereto, such that the upper holder 210 and the lower holder 230 may be coupled to the other upper holder 210 and lower holder 230.

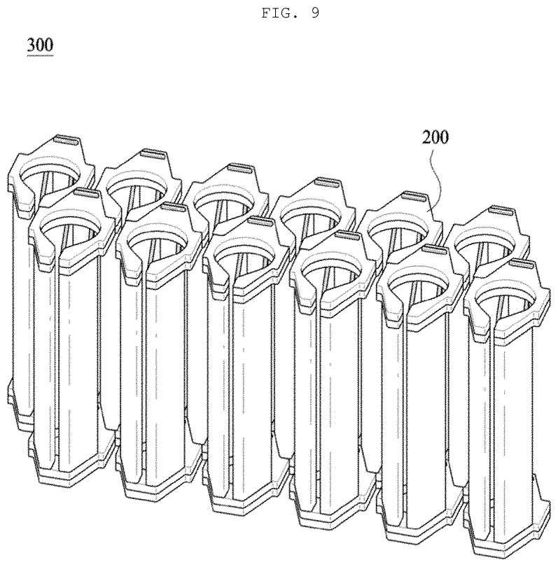

Therefore, as illustrated in FIG. 9, a plurality of modular specimen tube holders 200 may be horizontally coupled to each other to form a specimen tube holder module 300, and if necessary, the number of modular specimen tube holders 200 may be adjusted.

On the other hand, a specimen tube holder module 300 of FIG. 9 illustrates that the modular specimen tube holders 200 are coupled in two rows in a horizontal direction, but is not necessarily limited thereto, and the modular specimen tube holders 200 may also be coupled to form a circular shape to be formed in a rotary type. In this way, various types of specimen tube holder modules 300 may be formed using a plurality of modular specimen tube holders 200.

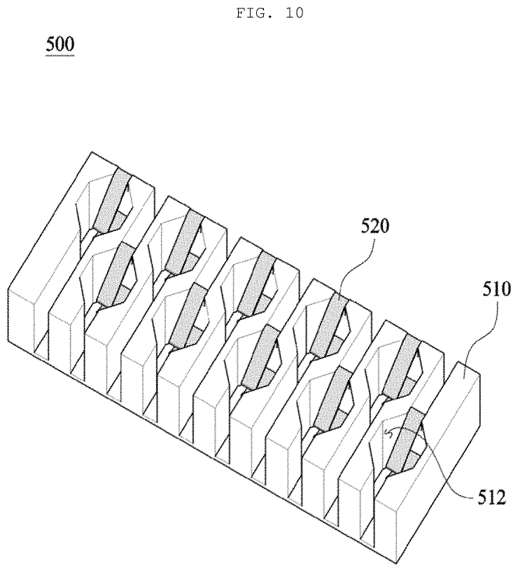

A block-type specimen tube holder 500 according to a third embodiment of the present invention may include a holder block 510 and a tension spring 520 as illustrated in FIG. 10.

The holder block 510 is made of a conductive material, and at least one accommodation space 512 into which the specimen tube 10 is inserted may be formed in the holder block 510.

At this time, an inner side surface of the holder block 510 facing the specimen tube 10 may be formed to be longly in contact with at least a portion of the outer circumferential surface of the specimen tube 10 accommodated in the accommodation space 512 in the vertical direction.

In addition, the accommodation space 512 may be formed to be longly opened in the vertical direction toward one side of the holder block 510. Through the opened portion of the accommodation space 512, a level of the specimen contained in the specimen tube 10, specimen information, a state of the sample, or a barcode attached to the specimen tube 10 may be confirmed.

In addition, a tension spring 520 for elastically pressing the specimen tube 10 inserted into each accommodation space 512 of the holder block 510 toward an inner side surface of the accommodation space 512 may be provided in each accommodation space of the specimen tube holder 500. As the tension spring 520 presses the specimen tube 10 toward the inner side surface of the accommodation space, an area of the holder block 510 in contact with the specimen tube 10 may be increased, and accordingly, a capacitance of the specimen tube holder 500 may be increased while the specimen tube 10 is stably supported on the inner side surface of the holder block 510.

In addition, the tension spring 520 may be formed on an opposite side of the opened position of the accommodation space 512 so as to press the specimen tube 10 in the direction in which the accommodation space 512 is opened.

In addition, as the material of the holder block 510, any material having conductivity is possible, but since it needs to have some degree of rigidity and mechanical processing is possible, metals such as aluminum, copper, and stainless steel, or a conductive polymer may be used as the material of the holder block 510.

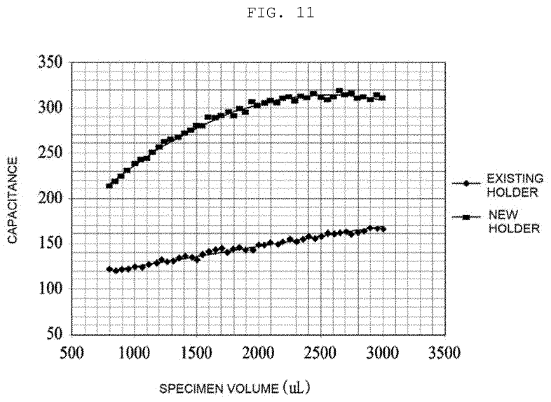

Meanwhile, FIG. 11 is a diagram illustrating a change in capacitance of a conventional specimen tube holder and a specimen tube holder of the present invention when the same specimen and the same sample are subjected to liquid level detection by the capacitance liquid level detection method.

Referring to FIG. 11, it may be seen that the specimen tube holder of the present invention applied with a conductive material exhibits an average increase of about twice the capacitance compared to the conventional specimen tube holder made of a non-conductive material, and based on this, it may be inferred that the liquid level detection sensitivity of the specimen is improved.

Since the capacitance of the conventional specimen tube holder made of the non-conductive material considers only a one-dimensional distance constant, but the specimen tube holder of the present invention to which the conductive material of the present invention is applied has the side holder or the holder block made of the conductive material surrounding the specimen and the sample contained in the specimen tube, the contact area between the specimen tube and the specimen tube holder increases. According to the present invention, since the side holder or the holder block itself made of a conductive material acts as an electrode plate, an effect of increasing an area of the electrode plate is exerted, and accordingly, the capacitance of the specimen tube holder increases, thereby making it possible to improve the sensitivity of the liquid level detection of the specimen and the sample.

As described above, the embodiments according to the present invention have been described, and the fact that the present invention may be embodied in other specific forms without departing from its spirit or scope in addition to the above-described embodiments is apparent to those skilled in the art. Therefore, the above-described embodiments should be regarded as illustrative and not restrictive, and accordingly, the present invention is not limited to the above description, but may be changed within the scope of the appended claims and its equivalent.

### DESCRIPTION OF REFERENCE NUMERALS

10: specimen tube

100: specimen tube holder

110: central holder

120: side holder

140: accommodation space

150: tension spring

200: modular specimen tube holder

210: upper holder

220: side holder

230: lower holder

240: accommodation space

250: tension spring

300: specimen tube holder module

500: block-type specimen tube holder

510: holder block

512: accommodation space

520: tension spring

1. A specimen tube holder comprising:
a central holder; and
a side holder made of a conductive material, disposed to be spaced apart from a side surface of the central holder to form an accommodation space into which a specimen tube is inserted between the central holder and the side holder, and formed so that an inner side surface is longly in contact with at least a portion of an outer circumferential surface of the specimen tube accommodated in the accommodation space in a vertical direction.

2. The specimen tube holder of claim 1, wherein a groove having a shape corresponding to a shape of the outer circumferential surface of the specimen tube is formed on a surface of the side holder facing the specimen tube.

3. The specimen tube holder of claim 2, wherein a tension spring is provided for elastically pressing the specimen tube accommodated in the accommodation space toward the side holder.

4. The specimen tube holder of claim 3, wherein the side holder is installed on one surface of the central holder and the other surface opposite thereto to be spaced apart from each other, and
the tension spring is installed on both side surfaces of the central holder.

5. The specimen tube holder of claim 1, wherein a long opening is formed in a side surface of the side holder in the vertical direction.

6. A modular specimen tube holder comprising:
an upper holder having an opening through which a specimen tube enters;
a lower holder located under the upper holder and connected to a lower side surface of the specimen tube; and
a side holder provided between the upper holder and the lower holder, made of a conductive material, and formed so that an inner side surface is longly in contact with at least a portion of an outer circumferential surface of the specimen tube entered through the opening of the upper holder in a vertical direction.

7. The modular specimen tube holder of claim 6, wherein the opening of the upper holder is formed so that a portion of a circumference thereof is opened toward a diameter direction.

8. The modular specimen tube holder of claim 6, wherein a tension spring is provided for elastically pressing the specimen tube inserted through the opening of the upper holder toward the side holder.

9. The modular specimen tube holder of claim 6, wherein an opening is longly formed in a side surface of the side holder in the vertical direction.

10. The modular specimen tube holder of claim 6, wherein the upper holder and the lower holder are provided to be horizontally coupled to connected upper and lower holders.

11. A block-type specimen tube holder comprising:
a holder block made of a conductive material, having one or more accommodation spaces into which a specimen tube is inserted, and formed so that an inner side surface is longly in contact with at least a portion of an outer circumferential surface of the specimen tube inserted into an accommodation space in a vertical direction; and
a tension spring provided in each accommodation space to elastically press the specimen tube inserted into the each accommodation space toward the inner side surface of the accommodation space.

12. The block-type specimen tube holder of claim 11, wherein each accommodation space is formed to be opened in the vertical direction toward a side surface of the holder block.
